(19) United States
(12) Patent Application Publication
(10) Pub. No.: US 2024/0334930 A1
(43) Pub. Date: Oct. 10, 2024

(54) PHYTOSANITARY COMBINATIONS COMPRISING CARVACROL COMPOSITIONS AND THEIR USE

(71) Applicant: SIPCAM OXON S.P.A., Milano (MI) (IT)

(72) Inventors: Elisa GALIMBERTI, Lissone (MB) (IT); Claudio DACARRO, Milano (MI) (IT); Giovanni POZZI, Besana in Brianza (MB) (IT); Stefano CIANNAMEA, Serravalle Sesia (VC) (IT); Pietro QUERZOLA, Melegnano (MI) (IT); Alessandra FRATANGELI, Milano (MI) (IT); Francesca BORGO, Rho (MI) (IT)

(21) Appl. No.: 18/293,529

(22) PCT Filed: Aug. 10, 2022
(86) PCT No.: PCT/IB2022/057440

§ 371 Date: Jan. 30, 2024

(30) Foreign Application Priority Data
Aug. 10, 2021 (IT) 102021000021707

(51) Int. Cl. A01N 31/08; A01N 37/20; A01N 43/16; A01N 43/40; A01N 43/54; A01N 43/653; A01N 43/90; A01N 53/00; A01N 59/02; A01N 59/20; A01N 59/26; A01P 3/00; A01P 7/04

(52) U.S. Cl. CPC A01N 31/08; A01N 37/20; A01N 43/16; A01N 43/40; A01N 43/54; A01N 43/653; A01N 43/90; A01N 53/00; A01N 59/02; A01N 59/20; A01N 59/26; A01P 3/00; A01P 7/04

(57) ABSTRACT

The present invention refers to novel phytosanitary combinations comprising carvacrol, the compositions and the kits comprising said combinations and their use on pathogens of agricultural crops.

### SUMMARY

The present invention refers to novel phytosanitary combinations comprising carvacrol, the compositions and the kits comprising said combinations and their use in the agricultural field as pesticides.

### TECHNICAL BACKGROUND

Several chemicals, of natural or synthetic origin, are used as plant protection products, where plant protection product means compounds or compositions used in agriculture to at least partially kill the parasites damaging cultivated plants, such as for example fungi, pathogenic insects and the like, in order to protect the health of said plants and to guarantee their survival. Said plant protection products or phytosanitary products are also named, sometimes inappropriately, parasiticides, fungicides, pesticides and biocides.

Carvacrol, or 2-methyl-5-isopropylphenol, having the following formula (I)

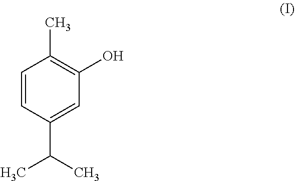

is present for example in the essential oil of oregano (Origanum spp.) and of Satureja (Satureja spp.) and possesses very good antifungal and antibacterial properties, showing at the same time a limited toxicity towards higher animal species.

Contrary to carvacrol, most of the compounds showing pesticidal activity capable of protecting the plans also have some toxicity on higher animal organisms such as mammals, fishes, poultry or other animal species, with a dose-dependent effect. For this reason, there are law limits to the plant protection products which can be administered, for example maximum dosages per hectare, with the result that sometimes the authorized quantities turn out to be insufficient to realize an effective phytosanitary action.

In addition to this, the plant protection products are often effective only against a narrow range of parasites, for example only against fungi or only against insects or mites, and the like.

There is therefore a need of having available novel products with phytosanitary action which are really effective in the protection of a plurality of plants and low in toxicity towards the auxiliary and pollinator insects. In addition, the occurrence of resistant fungal strains and species of insects poses the

need for novel mechanisms of action (MoA) with broad spectrum to keep the effectiveness of controlling the authorized plant protection products at a satisfactory level.

### OBJECTS OF THE INVENTION

It is an object of the invention to provide combinations of compounds having an effective phytosanitary action which is significantly higher than the activity of the single phytosanitary agent and that, at the same time, reduce the impact to the health of higher animals, auxiliary and pollinator insects and the environment.

It is a further object of the invention to provide compositions suitable for the administration of said combinations to plants.

It is a further object of the invention to provide a kit suitable for the preparation and administration of said combinations to plants.

It is a further object of the invention to provide the use of such combinations, compositions and kits as antifungal and insecticidal agents.

### DESCRIPTION OF THE INVENTION

Subject-matter of the invention, according to one of the aspects thereof, is a combination with phytosanitary action comprising, and alternatively consists of, carvacrol and at least one further plant protection product selected from:
a. demethylation inhibitors, preferably prothioconazole;
b. “quinone outside” inhibitors, preferably azoxystrobin;
c. succinate dehydrogenase inhibitors, preferably boscalid;
d. inhibitors of the cellular respiration at mitochondrial level, preferably fluazinam;
e. fungicides with multi-site action, preferably copper in active forms, more preferably copper oxychloride and sulfur;
f. inhibitors of the parasite penetration into the plant tissue, preferably cymoxanil;
g. inhibitors of mitosis and cell division, preferably zoxamide;
h. plant defense inductors, preferably potassium phosphite (or potassium phosphonate), fosetyl-aluminium and laminarin;
i. inhibitors of growth factors of the insects, preferably azadirachtin; and
j. modulators of sodium channels, preferably lambda-cyhalothrin.

With “carvacrol” it is meant herein the compound of formula (I) above, whether of natural origin, i.e. obtained by extraction from the plants containing it, or produced by synthesis. The term “carvacrol” also includes the extracts of the plants containing carvacrol, for example the oils extracted from said plants; in this case, the amounts of carvacrol set forth herein are always referred to carvacrol and not to the amounts of extract.

With “further plant protection product” it is meant herein another compound with antifungal and/or insecticidal activity.

With “phytosanitary action” it is meant an action directed at protecting the plants from the parasites; preferably, the phytosanitary action of the combination is antifungal and/or insecticidal.

According to a preferred embodiment, the combination of the invention comprises carvacrol and at least one further plant protection product selected from (a), (d), (e), (f), (g), (h), (i) and (j).

According to a preferred embodiment, the combination of the invention comprises carvacrol and prothioconazole, preferably in a weight ratio carvacrol/prothioconazole of 40-1/1, more preferably 25-1/1, for example 20-1/1. According to this embodiment, preferably a higher carvacrol/prothioconazole ratio will be used for the treatment of seeds and a lower ratio for the treatment of the plant leaves.

According to a preferred embodiment, the combination of the invention comprises carvacrol and fluazinam, preferably in a weight ratio carvacrol/fluazinam of 51/1, more preferably 3-1/1, for example about 2-1/1.

According to a preferred embodiment, the combination of the invention comprises carvacrol and cymoxanil, preferably in a weight ratio carvacrol/cymoxanil of 10-1/1, more preferably 8-1/1, for example about 5-2/1.

According to a preferred embodiment, the combination of the invention comprises carvacrol and zoxamide, preferably in a weight ratio carvacrol/zoxamide of 10-1/1, more preferably 8-1/1, for example about 5-2/1.

According to a preferred embodiment, the combination of the invention comprises carvacrol and a phosphite, preferably potassium phosphite, preferably in a weight ratio carvacrol/potassium phosphite of 1/10-1, more preferably 1/8-1, for example about 1/4-1.

According to a preferred embodiment, the combination of the invention comprises carvacrol and copper, preferably in the form of copper oxychloride, preferably in a weight ratio carvacrol/copper of 1/10-1, more preferably 1/8-1, for example about 1/4-1.

According to a preferred embodiment, the combination of the invention comprises carvacrol and copper, preferably in the form of copper oxychloride, preferably in a weight ratio carvacrol/copper of 10-1/1, more preferably 5-1/1, for example about 4-1/1.

According to a preferred embodiment, the combination of the invention comprises carvacrol and azadirachtin, preferably in a weight ratio carvacrol/azadirachtin of 20-1/1, more preferably 15-2/1, for example about 10-3/1.

According to a preferred embodiment, the combination of the invention comprises carvacrol and lambda-cyhalothrin, preferably in a weight ratio carvacrol/lambda-cyhalothrin of 550-40/1, more preferably 400-50/1, for example about 300-60/1.

According to a preferred embodiment, the combination of the invention comprises carvacrol and laminarin, preferably in a weight ratio carvacrol/laminarin of 15-1/1, more preferably 10-3/1, for example about 6-7/1.

According to a preferred embodiment, the combination of the invention comprises carvacrol and sulfur, preferably in a weight ratio carvacrol/sulfur of 1-0.1/1, more preferably 0.5-0.1/1, for example about 0.3-0.2/1.

According to a preferred embodiment, the combination of the invention comprises, and alternatively consists of, carvacrol and at least one further plant protection product selected from prothioconazole; cymoxanil; copper, preferably in the form of copper oxychloride; lambda-cyhalothrin; and azadirachtin, preferably in the weight ratios set forth above.

The combinations of the invention have surprisingly shown a synergistic effect and allowed to reduce, in some cases, the doses of the plant protection product in the mixture. It is easily understood that this result represents a significant technical advancement since the addition of carvacrol, to another conventional plant protection product, allowed to achieve an effective synergistic antifungal and insecticidal action.

If desired or necessary, the combination of the invention can comprise carvacrol and two or more plant protection products as defined above.

According to an embodiment, the combination of the invention comprises carvacrol and only one further plant protection product as defined above.

Subject-matter of the invention, according to another of the aspects thereof, is a method to obtain a phytosanitary effect, in particular to obtain an antifungal and/or insecticidal effect in the agricultural field, comprising administering an effective amount of the combination of the invention to a cultivation of plants in need thereof.

According to an embodiment, the method of the invention comprises administering the components of the combination simultaneously.

According to this embodiment, it is for example possible to extemporaneously mix a composition comprising carvacrol with at least one composition comprising one further plant protection product as defined above and dilute the mixture with water, before the administration to crops. Such mixing can for example occur in suitable containers, such as barrels, where usually the plant protection products are diluted before the administration to plants; the dilution is carried out until obtaining a suitable concentration of the active ingredients. It is indeed known that the plant protection products are marketed in concentrated compositions and must be diluted before their use, precisely usually diluted with water in containers such as barrels.

Alternatively, it is however possible to administer the components of the combination separately to crops, over a short period of time.

The compositions comprising carvacrol and the compositions comprising the further plant protection product are known and commercially available.

By way of example, such compositions can be in the solid form, e.g. in the form of wettable or soluble powders, microgranules or granules which are soluble or dispersible in water and the like, or liquid such as for example in the form of concentrated suspensions with an aqueous base, solutions, emulsifiable concentrates, microcapsule suspensions and the like.

These compositions can comprise, in addition to the active ingredients, also some excipients such as those usually employed in the technical field.

With “excipients” it is meant herein to denote components which are added to the composition to promote its stability in order to allow its storage and to provide mixtures suitable for the administration to plants. Conventional excipients used are for example solvents; diluents; surfactants; stabilizing agents; coloring agents; penetrating agents for plants; pH regulators such as organic or inorganic acids; anti-foaming agents; thickeners; anti-drift agents; and the like.

The phytosanitary composition of the invention preferably comprises carvacrol in a range of concentrations from 5 wt % to 80 wt %, with respect to the total weight of the formulated product.

The amounts of the combination to be administered depend on the kind of treatment to be performed, e.g. if preventive or curative, as well as on the type and health state of the crop to be treated, the seasonality, etc. The technician of the field is able to select the most suitable amount of the composition to achieve the desired effect, also relying on the examples provided in the following Experimental Section.

The Experimental Section show some assays realized by the Applicant by mixing and diluting with water one composition comprising carvacrol and one composition comprising the further plant protection product (defined as “partner” in the Tables). As it can be noticed, the combination resulting in obtaining a synergistic effect, a fact that allows in some cases to reduce the dosage of the further plant protection product usually applied to the crops.

As stated, this result represents a surprising and unexpected technical effect which solves the problem of reducing the dosages necessary to obtain a phytosanitary effect.

Subject-matter of the invention, according to another of the aspects thereof, is also a kit comprising at least one composition comprising carvacrol and at least one composition comprising one further plant protection product as defined above.

According to a preferred embodiment, the invention comprises at least one composition comprising carvacrol in concentrated form and at least one composition comprising one further plant protection product as defined above in concentrated form.

The compositions within the kits containing carvacrol and the at least one further plant protection product are intended to the mixing and to the following dilution before being administered to plants in need of a phytosanitary treatment.

The term “combination” includes herein both mixtures of carvacrol and the at least one further plant protection product in concentrated form and said mixtures in diluted form, preferably diluted with water.

The kit of the invention can contain, in addition to the compositions as defined above, also an instruction sheet suggesting how to mix, dilute and administer the combination of the invention to plants.

Subject-matter of the invention, according to another of the aspects thereof, is also a composition comprising the combination of the invention and one or more conventional excipients such as for example solvents; diluents; surfactants; stabilizing agents; coloring agents; penetrating agents for plants; pH regulators such as organic or inorganic acids, anti-foaming agents, thickeners, anti-drift agents and the like.

The one skilled in the field is perfectly capable of selecting the most suitable excipients to formulate each combination of the invention in a composition that is stable to storage and can be administered to plants in a suitable manner.

The compositions of the invention are prepared according to the conventional methods known in the art, e.g. by mixing the components and the excipients for a convenient period of time. Preferably, the compositions of the invention are then packaged in suitable multi-dose or single-dose containers.

For the application, the combinations and the compositions of the invention, once diluted as known to the one skilled in the art, are used for the treatment (foliar spray, fertigation treatment to the soil) of the plants in need thereof or by precise and localized application to the seed.

Subject-matter of the invention, according to another of the aspects thereof, is the use of the combination, the kit and the composition of the invention as phytosanitary agents, in particular as antifungal and/or insecticidal agents, in agricultural field. By way of example, the combination, the composition and the kit of the invention can be used as anti-parasitic agent, in particular antifungal and/or insecticidal, on herbaceous and arboreal plants, for example corn, apple, wheat, grapevine, tomato, eggplant etc.

According to a preferred embodiment, subject-matter of the invention is the use of the combination, the composition and the kit of the invention to prevent or treat a variety of fungal infections for example, but not limited to, infections by Oomycetes, Aschomycota, Basidiomycota, e.g. Pythium, V. inaequalis, P. recondita, P. viticola, P. infestans.

According to a preferred embodiment, subject-matter of the invention is the use of the combination, the composition and the kit of the invention as an insecticide to kill a variety of plant pests included, but not limited to, Hemiptera, Lepidoptera, e,g, the D. plantaginea and H. armigera.

According to an embodiment, the combination carvacrol and demethylation inhibitors, preferably prothioconazole, is particularly useful for the treatment of cereals, for example but not limited to, rice, corn and wheat.

According to an embodiment, the combination carvacrol and “quinone outside” inhibitors, preferably azoxystrobin, is particularly useful for the treatment of solanaceae, for example but not limited to, eggplants, tomatoes, peppers and potatoes. According to an embodiment, the combination carvacrol and multi-acting fungicides, preferably copper in active forms, more preferably copper oxychloride, is particularly useful in the treatment of grapevine.

According to an embodiment, the combination carvacrol and inhibitors of growth factors, preferably azadirachtin, is particularly useful in the treatment of horticultural plants.

Subject-matter of the invention, according to one of the aspects thereof, is a method to obtain an antifungal and/or insecticidal effect in the agricultural field, comprising the administration of an effective amount of the combination, the composition or the kit of the invention to a cultivation of plants in need thereof.

### Experimental Section

The efficacy of some representative combinations of the invention has been verified by means of the assays, whose results are set forth in the following Tables 1 and 2.

The tests have been carried out in a greenhouse, for the period of time shown in Table 1.

In the Tables:
The further plant protection product of the combination is shown in the Tables as “partner”;
“target” represents the parasite to be reduced/eliminated;
“EC” means emulsifiable concentrate;
“L” means liter;
“SC” means concentrated suspension;
“CS” means suspension of microcapsules
“gai” means grams of active ingredient;
“ha” means one hectare;
“ratio” means the carvacrol/partner weight ratio;
“mix efficacy” means the efficacy of the combination shown as % of disease control, with reference to an “untreated” plant and the following calculation is done:

A=% of disease of the untreated plant

B=% of disease of the treated plant

% of disease control=[(A−B)/A]×100;
The synergy has been evaluated by the calculation of the Colby equation. For the determination of the Colby coefficient, which identifies whether the effect of an active ingredient (in this case carvacrol) on another active ingredient may be classified as “SYNERGISTIC”, it is necessary to consider the efficacy of the product based on carvacrol (X) only, the efficacy of the product based on the partner only (the further plant protection product) selected (Y) and the observed efficacy of the mixture (O). With the first two values, it is possible to calculate the theoretical efficacy (E) by applying the Gowing equation or the Limpel equation. The effect is then defined as synergistic if O results to be greater than E. In the following there is an example of the calculation of the evaluation of the effect of the carvacrol +prothioconazole mixture (Test 1 of Table 1):

$$X = 65 \%$$

$$Y = 39 \%$$

$$E = X + [ Y ( 100 - X ) ] / 100$$

$$E = 65 + [ 39 ( 100 - 65 ) ] / 100 = 78.65$$

$$or$$

$$E = X + Y - ( XY / 100 )$$

$$E = 65 + 39 - ( 2 \; 535 / 100 ) = 78.65 .$$

In the specific case, since the % of the disease control observed is equal to “O=98%”, and therefore O is greater than E, the effect of carvacrol on the efficacy of prothioconazole in the doses shown in Test 1 of Table 1 is identified as “SYNERGISTIC” (see S. R. Colby, “Weeds”, Vol. 15, No. 1 (1967), pages 20-22, Ed. Cambridge University Press), with Colby coefficient equal to O−E=19.35.

TABLE 1

| | Tested formulated | | | | | |
|---|---|---|---|---|---|---|
| | product | Partner | Cultivation | Target | Kingdom and Phylum | Kind of Study |
| 1 | 300 g/l Carvacrol EC | 400 g/l Prothioconazole SC | Rice | Pyricularia oryzae | Fungi, Ascomycota | In vitro |
| 2 | 300 g/l Carvacrol EC | 250 g/l Azoxystrobin SC | Rice | Pyricularia oryzae | Fungi, Ascomycota | In vitro |
| 3 | 200 g/l Carvacrol ME | 400 g/l Prothioconazole SC | Corn | Pythium ultimum | Chromista, Oomycotha | In vivo (seed dressing) |
| 4 | 300 g/l Carvacrol EC | 400 g/l Prothioconazole SC | Wheat | Puccinia recondita | Fungi, Basidiomycota | In vivo (foliar) |
| 5 | 300 g/l Carvacrol EC | 250 g/l Azoxystrobin SC | Wheat | Puccinia recondita | Fungi, Basidiomycota | In vivo (foliar) |
| 6 | 300 g/l Carvacrol EC | 45 g/l Laminarin SL | Wheat | Puccinia recondita | Fungi, Basidiomycota | In vivo (foliar) |
| 7 | 200 g/l Carvacrol EC | 250 Prothioconazole g/l EC | Wheat | Puccinia recondita | Fungi, Basidiomycota | In vivo (foliar) |
| 8 | 200 g/l Carvacrol EC | 250 Prothioconazole g/l EC | Wheat | Septoria tritici | Fungi, Ascomycota | In vivo (foliar) |
| 9 | 300 g/l Carvacrol EC | 250 g/l Azoxystrobin SC | Tomato | Phytophthora infestans | Chromista, Oomycotha | In vivo (foliar) |
| 10 | 300 g/l Carvacrol EC | 380 g/l Copper oxychloride SC | Grapevine | Plasmopara viticola | Chromista, Oomycotha | In vivo (foliar) |
| 11 | 300 g/l Carvacrol EC | 26 g/L Azadirachtin EC | Cabbage | Myzus persicae | Animalia, Artropoda | In vivo (foliar) |
| 12 | 300 g/l Carvacrol EC | 510 g/l Potassium phosphonate SL | Grapevine | Plasmopara viticola | Chromista, Oomycotha | In vivo (foliar) |

| | | | | | | | | Calculation of Synergy (Colby equation) | |
|---|---|---|---|---|---|---|---|---|---|
| | Dose of carvacrol | | | | Observed | Observed | Observed | Theoretical | Synergistic |
| | formulated product in l/ha | | Dose of partner in l/ha | | efficacy of | efficacy of | efficacy of | efficacy | Effect: O > E |
| | (volume of water 1000 l/ha) | | (volume of water 1000 l/ha) | | Carvacrol (X) | Partner (Y) | MIX (O) | MIX (E) | Additive: O = E |
| 1 | 0.25 | l/ha | 0.01 | l/ha | 65% | 39% | 98% | 79% | SYNERGISTIC |
| 2 | 0.25 | l/ha | 0.0001 | l/ha | 42% | 44% | 72% | 68% | SYNERGISTIC |
| 3 | 3 ml/1000 seeds | | 0.08 ml/1000 seeds | | 38% | 77% | 88% | 86% | SYNERGISTIC |
| 4 | 1.5 | l/ha | 0.05 | l/ha | 24% | 83% | 92% | 87% | SYNERGISTIC |
| 5 | 1.5 | l/ha | 0.005 | l/ha | 24% | 96% | 99% | 97% | SYNERGISTIC |
| 6 | 1.5 | l/ha | 0.8 | l/ha | 4% | 18% | 35% | 21% | SYNERGISTIC |
| 7 | 1.5 | l/ha | 0.8 | l/ha | 61% | 82% | 94% | 93% | SYNERGISTIC |
| 8 | 1.5 | l/ha | 0.8 | l/ha | 3% | 66% | 89% | 67% | SYNERGISTIC |
| 9 | 2 | l/ha | 0.044 | l/ha | 20% | 97% | 98% | 97% | SYNERGISTIC |
| 10 | 1 | l/ha | 0.22 | l/ha | 90% | 97% | 99% | 94% | SYNERGISTIC |
| 11 | 1.04 | l/ha | 1.5 | l/ha | 20% | 35% | 68% | 48% | SYNERGISTIC |
| 12 | 2 | l/ha | 2 | l/ha | 95% | 76% | 100% | 99% | SYNERGISTIC |

TABLE 2

| | Tested | | | | | Kingdom |
|---|---|---|---|---|---|---|
| | formulated product | Partner | Reference | Cultivation | Target | and Phylum |
| 13 | 200 g/l | Zetaram plus | Zetaram plus | Grapevine | Plasmopara | Chromista, |
| | Carvacrol ME | (380 g/l copper SC) | (380 g/l copper SC) | | viticola | Oomycotha |
| 14 | 200 g/l | Siarkol | Heliosoufre S | Wheat | Erysiphe | Fungi, |
| | Carvacrol EC | (800 g/l sulfur SC) | (700 g/l sulfur SC) | | graminis | Ascomycota |

| | | | | | | | | Dose |
|---|---|---|---|---|---|---|---|---|
| | | | | | Partner or | | | reduction vs |
| | Kind of | Carvacrol | | Partner | reference | MIX | Reference | partner or |
| | Study | dose | | dose in mix | dose tested | efficacy | Efficacy | reference |
| 13 | In vivo | 2 | l/ha | 0.526 l/ha | 2 l/ha | 98% | 98% | 74% |
| | (foliar) | | | (200 g/ha copper) | (760 g/ha copper) | | | |
| 14 | In vivo | 1.5 | l/ha | 3 l/ha | 5 l/ha | 81% | 76% | 31% |
| | (foliar) | | | (2400 g/ha sulfur) | (3500 g/ha sulfur) | | | |

As it can be deduced from the results, the combinations with carvacrol of the invention have shown very interesting synergistic effects (Table 1). In some cases, combinations with significantly lower dosages of the further plant protection product (partner) have been assayed (Table 2) and good efficacy against pathogens has been observed as well.

The combination of 300 g/l carvacrol EC+240 g/l Zoxamide SC has been also tested on grapevine cultivations, and also in this case very interesting results have been observed.

Therefore, the combinations of the invention demonstrated to be particularly useful as phytosanitary agents, in particular as antifungal and/or insecticidal agricultural agents.

1. A phytosanitary composition comprising a combination comprising carvacrol and at least one further plant protection product selected from the group consisting of:
a. demethylation inhibitors;
b. “quinone outside” inhibitors;
c. succinate dehydrogenase inhibitors;
d. inhibitors of cellular respiration at mitochondrial level;
e. fungicides with multi-site action;
f. inhibitors of parasite penetration into plant tissue;
g. inhibitors of mitosis and cell division;
h. plant defense inductors;
i. inhibitors of growth factors of insects; and
j. modulators of sodium channels.

2. The phytosanitary composition according to claim 1, wherein said composition comprises carvacrol and one plant protection product selected from the group consisting of (a), (d), (e), (f), (g), (h), (i), (j) and mixtures thereof.

3. The phytosanitary composition according to claim 12, wherein said composition comprises one of:
a combination comprising carvacrol and prothioconazole in a weight ratio carvacrol/prothioconazole of 40-1/1;
a combination comprising carvacrol and fluazinam in a weight ratio carvacrol/fluazinam of 5-1/1;
a combination comprising carvacrol and cymoxanil in a weight ratio carvacrol/cymoxanil of 10-1/1;
a combination comprising carvacrol and zoxamide in a weight ratio carvacrol/zoxamide of 10-1/1;
a combination comprising carvacrol and potassium phosphite in a weight ratio carvacrol/potassium phosphite of 1/10-1;
a combination comprising carvacrol and copper in a weight ratio carvacrol/copper of 1/10-1;
a combination comprising carvacrol and copper oxychloride in a weight ratio carvacrol/copper oxychloride of 10-1/1;
a combination comprising carvacrol and azadirachtin in a weight ratio carvacrol/azadirachtin of 20-1/1;
a combination comprising carvacrol and lambda-cyhalothrin, in a weight ratio carvacrol/lambda-cyhalothrin of 550-40/1;
a combination comprising carvacrol and laminarin in a weight ratio carvacrol/laminarin of 15-1/1; and
a combination comprising carvacrol and sulfur in a weight ratio carvacrol/sulfur of 1-0.1/1.

4. The phytosanitary composition according to claim 12, characterized in that it comprises carvacrol and one further plant protection product selected from the group consisting of prothioconazole; cymoxanil; copper; lambda-cyhalothrin; azadirachtin and mixtures thereof.

5. A method to obtain a phytosanitary effect in agricultural field, said method comprising administering an effective amount of the composition according to claim 1, to a plant cultivation in need thereof.

6. The method according to claim 5, wherein said method comprises:
mixing and diluting with water, the composition according to claim 1, and;
administering an effective amount of the resulting liquid mixture to a plant cultivation in need thereof.

7. An antifungal and/or insecticidal composition comprising the phytosanitary composition according to claim 1 and at least one conventional excipient.

8. (canceled)

9. (canceled)

10. (canceled)

11. (canceled)

12. The phytosanitary composition according to claim 1, wherein:
said demethylation inhibitors comprise prothioconazole;
said “quinone outside” inhibitors comprise azoxystrobin;
said succinate dehydrogenase inhibitors comprise boscalid;
said inhibitors of cellular respiration at mitochondrial level comprise fluazinam;
said fungicides with multi-site action comprise copper in active forms and sulfur;
said inhibitors of parasite penetration into the tissue comprise cymoxanil;
said inhibitors of mitosis and cell division comprise zoxamide;
said plant defense inductors comprise potassium phosphite, fosetyl-aluminium and laminarin;
said inhibitors of growth factors of insects comprise azadirachtin; and
said modulators of sodium channels comprise lambda-cyhalothrin.

13. The phytosanitary composition according to claim 12, wherein said fungicides with multi-site action comprise copper oxychloride.

14. The phytosanitary composition according to claim 12, wherein said composition comprises one of:
a combination comprising carvacrol and prothioconazole in a weight ratio carvacrol/prothioconazole of 25-1/1;
a combination comprising carvacrol and fluazinam in a weight ratio carvacrol/fluazinam of 3-1/1;
a combination comprising carvacrol and cymoxanil in a weight ratio carvacrol/cymoxanil of 8-1/1;
a combination comprising carvacrol and zoxamide in a weight ratio carvacrol/zoxamide of 8-1/1;
a combination comprising carvacrol and potassium phosphite in a weight ratio carvacrol/potassium phosphite of 1/8-1;
a combination comprising carvacrol and copper oxychloride in a weight ratio carvacrol/copper oxychloride of 1/8-1;
a combination comprising carvacrol and copper oxychloride in a weight ratio carvacrol/copper oxychloride of 5-1/1;
a combination comprising carvacrol and azadirachtin in a weight ratio carvacrol/azadirachtin of 15-2/1;
a combination comprising carvacrol and lambda-cyhalothrin in a weight ratio carvacrol/lambda-cyhalothrin of 400-50/1;
a combination comprising carvacrol and laminarin in a weight ratio carvacrol/laminarin of 10-3/1; and
a combination comprising carvacrol and sulfur in a weight ratio carvacrol/sulfur of 0.5-0.1/1.

15. The phytosanitary composition according to claim 12, wherein said composition comprises one of:
a combination comprising carvacrol and prothioconazole in a weight ratio carvacrol/prothioconazole of 20-1/1;
a combination comprising carvacrol and fluazinam in a weight ratio carvacrol/fluazinam of 2-1/1;
a combination comprising carvacrol and cymoxanil in a weight ratio carvacrol/cymoxanil of 5-2/1;
a combination comprising carvacrol and zoxamide in a weight ratio carvacrol/zoxamide of 5-2/1;
a combination comprising carvacrol and potassium phosphite in a weight ratio carvacrol/potassium phosphite of 1/6-4;
a combination comprising carvacrol and copper oxychloride in a weight ratio carvacrol/copper oxychloride of 1/4-1;
a combination comprising carvacrol and copper oxychloride in a weight ratio carvacrol/copper oxychloride of 4-1/1;
a combination comprising carvacrol and azadirachtin in a weight ratio carvacrol/azadirachtin of 10-3/1;
a combination comprising carvacrol and lambda-cyhalothrin in a weight ratio carvacrol/lambda-cyhalothrin of 300-60/1;
a combination comprising carvacrol and laminarin in a weight ratio carvacrol/laminarin of 6-7/1; and
a combination comprising carvacrol and sulfur in a weight ratio carvacrol/sulfur of 0.3-0.2/1.

16. The phytosanitary composition according to claim 12, characterized in that it comprises carvacrol and one further plant protection product selected from the group consisting of prothioconazole; cymoxanil; copper in an active form; lambda-cyhalothrin; azadirachtin and mixtures thereof.

17. The phytosanitary composition according to claim 3, characterized in that it comprises carvacrol and one further plant protection product selected from the group consisting of prothioconazole; cymoxanil; copper in an active form; lambda-cyhalothrin; azadirachtin and mixtures thereof.

18. The phytosanitary composition according to claim 17, wherein said copper in an active form comprises copper oxychloride.

19. An antifungal and/or insecticidal composition comprising the combination according to claim 3 and at least one conventional excipient.

20. A method to obtain a phytosanitary effect in agricultural field, said method comprising administering an effective amount of the phytosanitary composition according to claim 3 to a plant cultivation in need thereof.

21. The method according to claim 20, wherein said method comprises:
mixing and diluting with water, the phytosanitary composition according to claim 3 and at least one composition comprising one further plant protection product, and;
administering an effective amount of the resulting liquid mixture to a plant cultivation in need thereof.
